(19) United States
(12) Patent Application Publication
(10) Pub. No.: US 2003/0218333 A1
(43) Pub. Date: Nov. 27, 2003

(54) System and method for joining tubes to sheets in a tubular heat transfer system

(75) Inventors: John P. Barber, Dayton, OH (US); Robert M. Columbus, Centerville, OH (US); Bruce D. Kouse, Springfield, OH (US); Duane C. Newman, London, OH (US)

Correspondence Address: MATTHEW R. JENKINS, ESQ., 2310 FAR HILLS BUILDING, DAYTON, OH, 45419, US

(73) Assignees: Elliott Tool Technologies Ltd., Dayton, OH; IAP Research, Inc., Dayton, OH

(21) Appl. No.: 10/154,700

(22) Filed: May 24, 2002

(51) Int. Cl. F16L 39/00

(52) U.S. Cl. 285/124.1; 285/382.4

(57) ABSTRACT

A system and method for expanding, joining or securing a plurality of tubes by electromagnetic expansion to a plurality of sheets in a tubular heat transfer system. The system and method involve the automatic sensing and positioning of a electromagnetic coil in operative relationship with at least a portion of a tube and an inner wall of a sheet and then energizing the electromagnetic coil to expand the portion of the tube to engage the inner wall of the sheet, thereby securing the tube thereto. A tubular heat transfer system tube expander and method are also shown.

### BACKGROUND OF THE INVENTION

1. Field of the Invention

The invention relates to a process for joining a tube, such as either a finned/enhanced tube or a prime/smooth surface tube, to at least one baffle, support, and/or tube sheet in the manufacture or maintenance of a tubular heat transfer system that uses an electromagnetic force to expand the tubes such that the outer surface of the tubes makes joining contact with apertures in the sheets.

2. Description of the Related Art

Tubular heat transfer systems include tubular systems of the type conventionally employed in air conditioners, heat exchangers, chillers, evaporators, boilers, and absorption units. The efficiency of tubular heat transfer systems is dependent in substantial measure on the efficiency of heat transferred between a media circulated through tubes and another media in heat exchange relation to the exterior of the tubes. The efficiency of heat transferred between the fluid surrounding the tubes is also enhanced by avoiding laminar flow of the fluid over the tubes.

The tubes used in a tubular heat transfer system are held in place by tube sheets situated on the end of the tubular heat transfer system. One or more tube supports sheets or baffle sheets may be provided to support the tubes between the tube sheets. Tubular heat transfer system tubes are supplied in various surface configurations that enable certain media to exchange heat better than others. The expander referenced here will expand either prime/smooth tubes or enhanced/finned tubes. Enhanced tubes are manufactured with a variety of inside surface raised ridges to provide turbulence to the flow through the tube, which enables greater heat transfer. Finned tubes are also manufactured with a variety of fin configurations on the outside surface and are selected based on the media that is being used to transfer heat over the tubes. Because of these two surface configurations, current tube expanders are unable to adequately expand these enhanced/finned tubes. Conventionally inside surface enhancing and outside surface finning are suspended in areas where the tube is to be joined to the support/baffle sheets and the end tube sheets because conventional tube expanders destroy internal ridges and overwork the tube and produce stress cracking at the junctions between the tube and the support/baffle sheets. In general, the ability to expand a tube is dependent on three conditions, the tube's thickness, diameter and the material the tube is made from.

U.S. Pat. No. 5,050,669 discloses a tube support which includes at least two parallel plates. The plates comprise a plurality of pins that approximate the leading and trailing edges of the plates in order to maintain the plates in a spaced relationship. The pins and plates provide support for the tubes. The use of electromagnetic force to expand a tube is described in U.S. Pat. No. 5,853,507 to Alie et al.; U.S. Pat. No. 6,050,121 to Daehn et al.; U.S. Pat. No. 4,947,667 to Gunkel et al.; U.S. Pat. No. 5,497,927 to Wilson; U.S. Pat. No. 4,924,584 to Harney; U.S. Pat. No. 4,059,882 to Wunder; U.S. Pat. No. 6,273,963 to Barber; U.S. Pat. No. 4,929,415 to Okaziki; U.S. Pat. No. 4,975,412 to Okaziki; U.S. Pat. No. 5,405,574 to Chelluri et al.; U.S. Pat. No. 5,611,230 to Chelluri et al.; U.S. Pat. No. 5,611,139 to Chelluri et al.; and U.S. Pat. No. 5,689,797 to Chelluri et al.

If the intersection or joint between the tubes and tube sheets or baffle sheets is not tight, fluid can leak from the heat exchanger shell over time. Also, 1f the intersection or joint between the tube and baffle or support sheets is not tight, fluid flow will cause vibration between the tube and baffle or support sheet that can lead to undesirable wearing of the tube at the interface. Over time this wearing can lead to premature failure of the tube.

There is, therefore, a need for a tubular heat transfer system manufacturing system and method for securing a plurality of tubes to any surrounding members, such as support plates, end plates or baffle plates which improves the securing of the tubes to the sheets and which can be used to join enhanced or finned tubes without damaging the tube.

### SUMMARY OF THE INVENTION

In one aspect this invention comprises a method for securing a conductive tube to at least one surrounding member of a tubular heat transfer system, the method comprising the steps of inserting a coil into the conductive tube until the coil is positioned in operative relationship with the conductive tube and the surrounding member and energizing the coil to expand at least a portion of the conductive tube to engage the at least one surrounding member, thereby securing the conductive tube to the at least one surrounding member.

Another aspect of the invention is a method for securing a plurality of conductive tubes to a plurality of plates to provide a tube bundle in a tubular heat transfer system, each of the plurality of plates having a plurality of inner walls defining a plurality of apertures, respectively, the method comprising the steps of situating the plurality of conductive tubes in the plurality of apertures, respectively, and magnetically increasing a diameter of at least a portion of at least one of the plurality of conductive tubes into engagement with at least one of the plurality of inner walls, thereby securing the at least one of the plurality of conductive tubes to the at least one of the plurality of inner walls.

Yet another aspect of this invention comprises a method for enlarging a first portion and a second portion of a conductive tube for use in a tubular heat transfer system, the system comprising the steps of: moving a coil to a first position in operative relationship with the first portion of the conductive tube, energizing the coil to enlarge the first portion of the conductive tube at the first position, moving the coil to the second position in operative relationship with the second portion of the conductive tube, and energizing the coil to enlarge the second portion of the conductive tube at the second position.

Still another aspect of this invention comprises a method for assembling a tubular heat transfer system having a housing, the method comprising the steps of providing a plurality of sheets, each of the plurality of sheets comprising a plurality of inner walls defining a plurality of apertures, respectively, positioning a plurality of conductive tubes into the plurality of apertures, respectively, inserting a coil into a first conductive tube of the plurality of conductive tubes, moving the coil to a first position in the first conductive tube, the first position corresponding to where a first inner wall of the plurality of inner walls, and the coil become substantially aligned, energizing the coil to enlarge the first portion of the first conductive tube adjacent the first inner wall to secure the first portion of the first conductive tube to the first inner wall, moving a second coil to a next position in the first conductive tube, the second position corresponding to where the second inner wall of a second sheet and the coil become substantially aligned, energizing the coil to enlarge the second portion of the first conductive tube adjacent the second inner wall to secure the second portion of the first conductive tube to the second inner wall, and repeating the steps until each of the plurality of conductive tubes is secured to the plurality of sheets.

Still another aspect of this invention comprises a tube bundle in a tubular heat transfer system, comprising a plurality of walls defining a plurality of apertures, respectively, a conductive tube situated in each of the plurality of apertures, and the conductive tube comprising an enlarged portion at each of a plurality of positions at which at least one of the plurality of walls surrounds the tube, thereby causing an interference fit between the enlarged portion and the at least one of the plurality of walls engaged by the enlarged portion, wherein the conductive tube comprises a continuously enhanced tube.

Yet another aspect of this invention comprises a tubular heat transfer system comprising, a plurality of sheets comprising a plurality of walls defining a plurality of apertures, respectively, a plurality of conductive tubes situated in the plurality of apertures, respectively, each of the plurality of walls surrounding each of the plurality of conductive tubes at a plurality of positions, each of the plurality of conductive tubes comprising an enlarged portion at each of the plurality of positions to cause an interference pressure between the enlarged portion and at least one of the plurality of walls engaged by the enlarged portion, thereby securing the plurality of conductive tubes to the plurality of walls to provide a tube bundle, a housing for surrounding the tube bundle, each of the plurality of conductive tubes comprising a continuously enhanced tube, and the plurality of sheets comprising a first tube sheet and a second tube sheet for sealing the housing to define an inlet area, a heat exchange area, and an outlet area, the housing having an inlet opening associated with the inlet area and an outlet opening associated with the outlet area, the plurality of conductive tubes enabling communication of fluid between the inlet area and the outlet area.

Still another aspect of this invention comprises a heat exchange tube expander for use relative to a tubular heat transfer system comprising a plurality of conductive tubes, the heat exchange tube expander comprising a coil for inserting into at least one of the plurality of conductive tubes and positioning at a plurality of positions in the at least one of the plurality of conductive tubes, a circuit coupled to the coil, the circuit comprising a capacitor discharge bank having a predetermined capacitance and being capable of receiving a predetermined charge voltage, and a switch for discharging the capacitor discharge bank to energize the coil to increase a diameter of at least a portion of the at least one of the plurality of conductive tubes to force an outer surface of the at least a portion into engagement with a surrounding member.

Yet another aspect of this invention comprises a method for securing a conductive tube to a surrounding member of a tubular heat transfer system, the method comprising the steps of inserting a coil into a conductive tube, moving the coil along the inside of the tube, when the coil reaches a position at which the tube intersects the surrounding member, while the coil is moving, energizing the solenoid to expand the portion of the conductive tube at the position of intersection and thereby securing the conductive tube to the surrounding member.

Still another aspect of this invention comprises a tube bundle for use in a tubular heat transfer system, comprising a plurality of sheets comprising a plurality of walls defining a plurality of apertures, respectively, a conductive tube situated in each of the plurality of apertures, and the conductive tube comprising a magnetically enlarged portion at each of a plurality of positions at which at least one of the plurality of walls surrounds the tube, thereby causing an interference fit between the magnetically enlarged portion and the at least one of the plurality of walls engaged by the magnetically enlarged portion.

Still another aspect of this invention comprises an expander assembly comprising an expander for magnetically enhancing at least a portion of a tube into a surrounding member as the expander is moved through the tube, and a sensor connected with the expander for sensing a position of the surrounding member.

The invention will be described in more detail by reference to specific embodiments thereof, the following description, and the accompanying drawings.

### BRIEF DESCRIPTION OF ACCOMPANYING DRAWING

FIG. 1 is a sectional view of a tubular heat transfer system in accordance with one embodiment of the invention;

FIG. 2 is a fragmentary sectional view of one end of the tubular heat transfer system shown in FIG. 1 before an end bell is secured thereto;

FIG. 3 is fragmentary sectional view showing a second end of the tubular heat transfer system shown in FIG. 1;

FIG. 4 is a fragmentary sectional view illustrating a relationship among a tube, tube sheet and coil before a portion of the tube is expanded;

FIG. 5 is a fragmentary sectional view similar to FIG. 4 showing the coils situated in operative relationship to the tube and tube sheet;

FIG. 6 is a fragmentary sectional view showing the portion of the tube expanded in accordance with one embodiment of the invention;

FIG. 7 illustrates a heat exchange tube expander and the various positions at which one or more portions of the tube can be expanded to secure it to any surrounding sheets;

FIG. 8 is a fragmentary sectional showing another coil situated in operative relationship with the tube and a baffle sheet;

FIG. 9 is a fragmentary sectional view illustrating a portion of the tube expanded after the coil shown in FIG. 8 was energized;

FIG. 10 is a circuit in accordance with one embodiment of the invention;

FIG. 11 is a sectional view taken along the line 11-11 in FIG. 2;

FIG. 12 is an enlarged fragmentary sectional view illustrating a relationship between a tube and an inner wall of the tube sheet shown in FIG. 11;

FIG. 13 is a sectional view taken along the line 12-12 in FIG. 1;

FIG. 14 is an enlarged fragmentary sectional view illustrating a relationship between a tube and an inner wall of a baffle sheet shown in FIG. 13;

FIG. 15 is chart illustrating various expansion results for an enhanced tube;

FIG. 16 is a schematic view illustrating a method in accordance with one embodiment of the invention;

FIG. 17A is a fragmentary view of a detector and coil assembly;

FIG. 17B is a sectional view taken along the line 17B-17B in FIG. 17A;

FIG. 18 is a view of a coaxial cable used in one embodiment;

FIG. 19 is a view of a direct drive expander before energization; and

FIG. 20 is a view of a direct drive expander after energization.

### DETAILED DESCRIPTION OF PREFERRED EMBODIMENT

Referring now to FIG. 1, a heat exchanger is shown. For ease of illustration, the invention will be described relative to a heat exchanger 10, but it is to be understood that the invention may be used with any type of tubular heat transfer system, such as a heat exchanger, a chiller, an air conditioner or an absorption unit. The heat exchanger 10 comprises a shell or housing 12 having a first flange 12a, a second flange 12b, a first end 12c, a second end 12d and an inner surface 12e. A first header or end cap 14 having a flange 14a is secured to the flange 12a and a second header or end cap 16 having a flange 16a is secured to flange 12b by nuts and bolts, as shown in FIG. 1.

The heat exchanger 10 comprises a tube bundle 18 situated in the housing 12. The tubes may be prime/smooth tubes or enhanced and/or finned tubes. The term “enhanced” is used herein to refer to tubes having an inside surface that is enhanced by providing a fine network of relatively closely spaced ridges that are arranged to enhance heat transfer between the tube and the heat exchange fluid (typically water) that flows through the tube. The term “finned” refers to an enhanced surface on the outside of the tube in the form of relatively finely spaced fins. Examples of enhanced tubes are provided in U.S. Pat. No. 4,216,826 to Furukawa Metals Co., Ltd. and U.S. Pat. No. 4,660,630 to Wolverine Tube, Inc., which are incorporated herein by reference and made a part hereof. The tube may comprise any electrically conductive material, such as copper or other suitable electrically conductive material.

The term “continuous enhanced” as used herein refers to a tube which is enhanced and/or finned and the enhanced and/or finned area is not periodically interrupted by a flat or smooth area. Conventionally, the enhanced surfaces on an enhanced tube are interrupted by smooth areas at the points of intersection with the support and baffle sheets because conventional expanders can overwork and crack the enhanced tube in the expanded areas. In accordance with certain embodiments of the invention, enhanced tube that is not interrupted by these smooth areas can be used. This has several advantages. First, the enhanced tube is less expensive to manufacture because it can be manufactured as continuous enhanced tube without altering or interrupting the manufacturing process to provide a smooth area. Second, the heat transfer efficiency of the tube is better because a greater surface area of tube is enhanced and/or finned. The combined effect of these two advantages should yield significant economies.

Particularly when using enhanced/finned tube, but potentially also with prime/smooth tube, it may be desirable to use a sealing media such as a conventional tube or plumbing solder or chemical sealant to seal any spaces between the tube outer surface and the surrounding sheets. In particular, the solder or chemical sealant will fill the spaces between the ridges and fins of an enhanced tube as well as the spaces between these ridges and fins and the surrounding sheets.

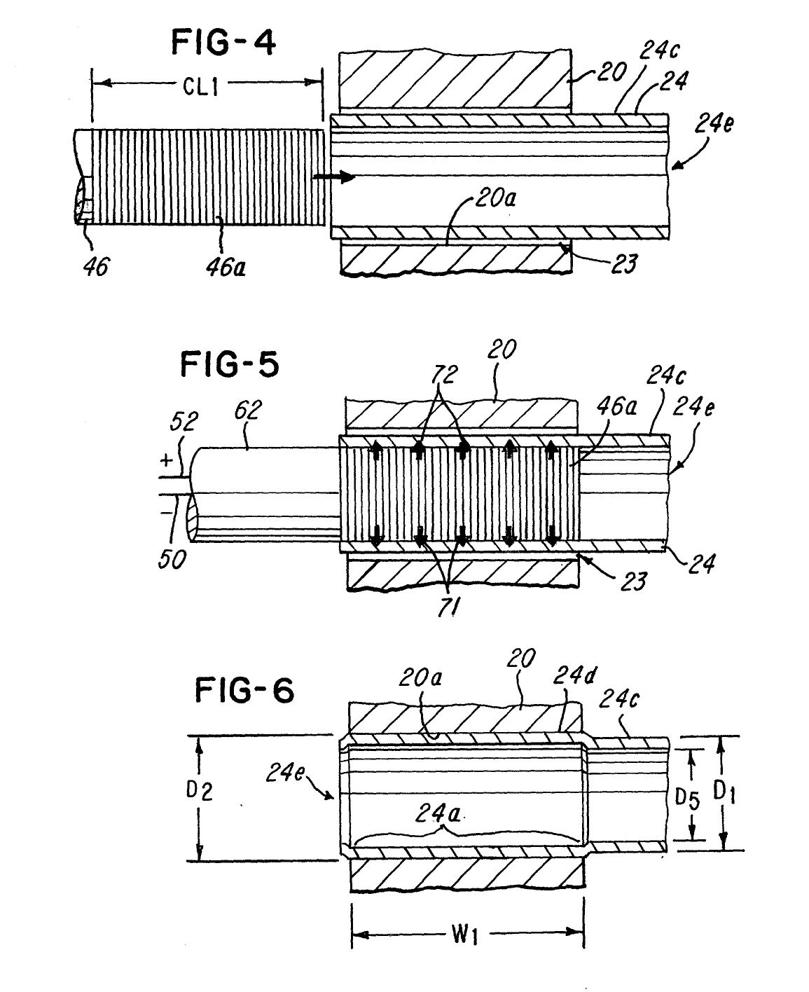

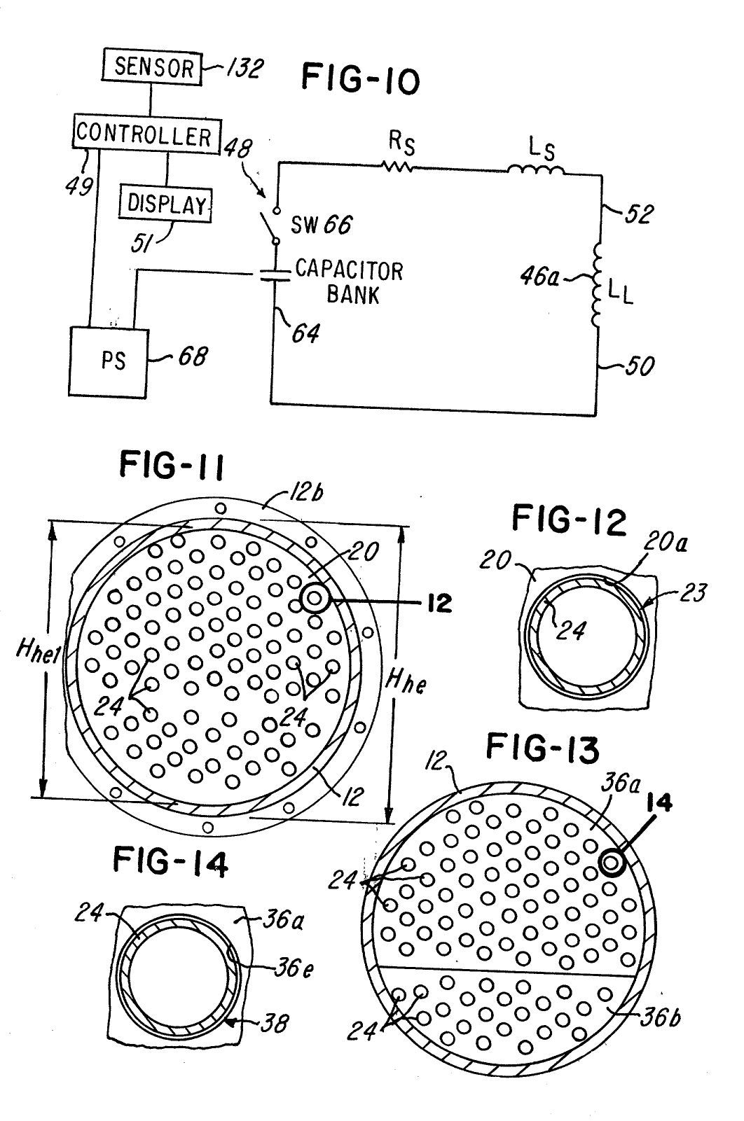

The tube bundle 18 comprises a first surrounding member or tube sheet 20 and a second surrounding member or tube sheet 22. In the embodiment being described, the tube sheets 20 and 22 are substantially the same and support a plurality of conductive tubes 24, as illustrated in FIG. 1. For ease of description, the invention will be described relative to tube sheet 20, but it should be understood that tube sheet 22 comprises substantially the same configuration. The tube sheet 20 comprises a plurality of inner walls, such as inner walls 20a (FIG. 12) that define a plurality of apertures 23 for receiving the plurality of conductive tubes 24, respectively, as illustrated in FIGS. 4 and 11.

The plurality of conductive tubes 24 are secured to the tube sheets 20 and 22 in accordance with the system and method described later herein. After one of the plurality of conductive tubes 24 is situated in one of the apertures 23, the system and method according to the invention may be applied to a portion, such as portion 24a in FIG. 6, of the conductive tube 24 to expand a diameter of the tube 24 from a first diameter D₁ (FIG. 6) to a second diameter D₂, thereby securing the tube 24 to the inner wall 20a of tube sheet 20. Note that after the plurality of conductive tubes 24 are secured to the tube sheets 20 and 22, they become aligned in a generally parallel relationship, as illustrated in FIG. 1.

To facilitate supporting the plurality of conductive tubes 24 and providing heat exchange, the tube bundle 18 also comprises a plurality of support sheets or baffle sheets 36a-36d. The plurality of baffle sheets 36a-36d support the tubes 24 between the tube sheets 20 and 22 and provide a baffle to interrupt the flow of fluid between a first inlet opening 26 and a first outlet opening 28 in the housing 12. As illustrated in FIGS. 13 and 14, each of the plurality of baffle sheets 36a-36d comprises a plurality of inner walls, such as inner walls 36e in sheet 36a, defining a plurality of apertures 38, respectively, for receiving the plurality of conductive tubes 24 as shown. The invention will be described relative to sheet 36a, but it should be understood that the sheets 36b-36d function and are configured in the same or similar manner.

As described later herein, the sheets 20, 22 and 36a-36d may be assembled with the tubes 24 to provide the tube bundle 18, which is then situated in housing 12. Alternatively, the sheets 20, 22 and 36a-36d may be welded, for example, to housing 12 and then the tubes 24 inserted in the apertures 23 and 38. Note that a heat exchange area 30 is defined by the housing 12 and sheets 20 and 22. Note also that an inlet area 32 and an outlet area 34 are provided when the end bells 14 and 16, respectively, are situated or mounted to the housing 12, as illustrated in FIG. 1. It should be understood that the tube sheets 20 and tubes 24 are sealed so that the heat exchange area 30 is not in fluid or gas communication with either the inlet area 32 or outlet area 34. Also, note that the plurality of conductive tubes 24 is in fluid communication with the inlet area 32 and outlet area 34. This permits fluid to flow into the inlet area 32 via a second inlet 14b, through the plurality of conductive tubes 24, into outlet area 34, and exit through a second outlet area 16b, as illustrated in FIG. 1. Substantially simultaneously with such fluid flow through the plurality of conductive tubes 24, a second fluid or gas is caused to flow through the first inlet opening 26, around the tubes 24 in the heat exchange area 30, and exit through the first outlet opening 28. The fluid flowing through the plurality of conductive tubes 24 is of a first temperature and the fluid flowing into the heat exchange area 30 and around the plurality of conductive tubes 24 is of a second temperature, which is different from the first temperature, thereby providing the desired heat exchange. In the embodiment being described, there is a temperature difference between the second fluid and the temperature of the fluid flowing through the plurality of conductive tubes 24. Also, at least one of the fluids may be a coolant, such as air, water, ethylene glycol or any suitable cooling fluid.

As mentioned, the plurality of conductive tubes 24 are secured to the inner walls 20a of tube sheets 20 and 22. The plurality of conductive tubes 24 are also secured to the inner walls, such as wall 36e of baffle sheet 36a, of baffle sheets 36a-36d (FIGS. 9 and 14) to secure the plurality of conductive tubes 24 to the baffle sheets 36a-36d. As illustrated in FIG. 1, the plurality of baffle sheets 36a-36d have a staggered arrangement to facilitate interrupting a flow path of fluid between the first inlet opening 26 and the first outlet opening 28 to facilitate heat exchange. It should be understood that the pattern of the plurality of apertures 38 defined by the plurality of inner walls 36e of the baffle sheets 36a-36d corresponds to the pattern of apertures or openings in the tube sheets 20 and 22, such as apertures 20a in FIG. 4.

As illustrated in FIGS. 6 and 9, each of the plurality of conductive tubes 24 is secured to the baffle sheets 36a-36d and tube sheets 20 and 22 by enlarging a portion, such as portion 24a (FIG. 6) and portion 24b (FIG. 9), of each plurality of conductive tubes 24 to provide an interference fit at the intersection or joint between the tube 24 and the walls 20a (FIG. 6) and 36e (FIG. 9). Note, for example, that the portion 24a (FIG. 6) is enlarged from the first diameter D₁ (FIG. 6) to the second diameter D₂ using the system and method of the invention. In this regard, it should be appreciated that each of the plurality of tubes 24 is enlarged only in the areas where the tube 24 is surrounded by the inner walls 20a and 36e, as illustrated in FIGS. 6 and 9, respectively. By enlarging only the portions 24a and 24b of tube 24 adjacent to the surrounding members, such as sheets 20, 22 and 36a-36d, the amount of time necessary to secure the plurality of conductive tubes 24 to the baffle sheets 36a-36d and tube sheets 20 and 22 is reduced. Advantageously, it should be appreciated that the entire process may be conducted from either end of the tube 24. Alternatively, the process may be performed so that approximately one-half of the tube 24, beginning at one end, is secured to surrounding members and then the coil 46a is removed and inserted into the other end of the tube 24 so that a second half of tube 24 may be processed from the other end.

In the embodiment being described, the baffle sheets 36a-36d (FIG. 1) and tube sheets 20 and 22 may each comprise different widths or thicknesses. For example, the tube sheets 20 and 22 may have a thickness or width W₁ (FIG. 6) that may vary, and the baffle sheets 36a-36d may each comprise a thickness or width W₂ (FIG. 9) that may vary in the embodiment being described. It should be appreciated that an outer diameter D₃ (FIG. 9) of the tube 24 is substantially the same as the diameter D₁ (FIG. 6) before the tube 24 is joined to the sheet 36a, which is the only baffle sheet joint shown in FIG. 9 for ease of illustration. After securing the tube 24 to the sheets 20 and 36a-36d, the tube 24 in FIG. 9 will have an enlarged diameter D₄ that is substantially the same as diameter D₂ in FIG. 6 of the diameters of the inner walls 36e and 20a, respectively, are the same. It should be appreciated, however, that these diameters D₂ and D₄ may be different and will vary depending on the diameter of the inner walls 20a and 36a, respectively. It has been found, however, that keeping the diameter of the inner walls 20a (FIG. 6) and 36e the same facilitates manufacturing, assembling and repairing the heat exchanger 10. The system and method for enlarging portion 24a and portion 24b of each of the plurality of conductive tubes 24 to secure the tubes 24 to the sheets 20, 22 and any surrounding sheets 36a-36d will now be described.

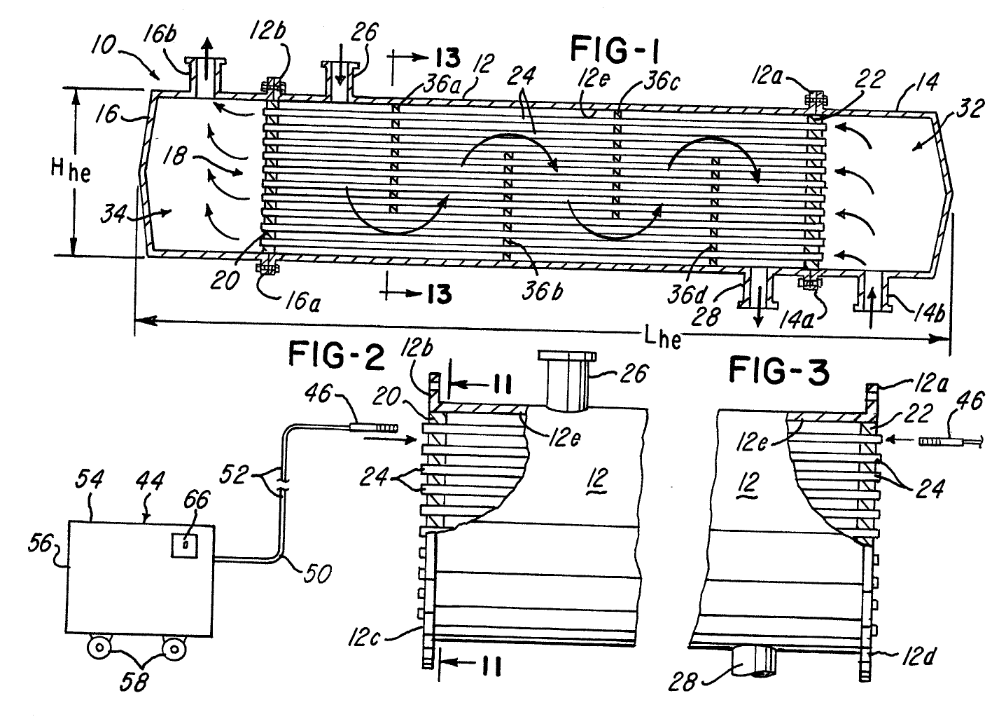

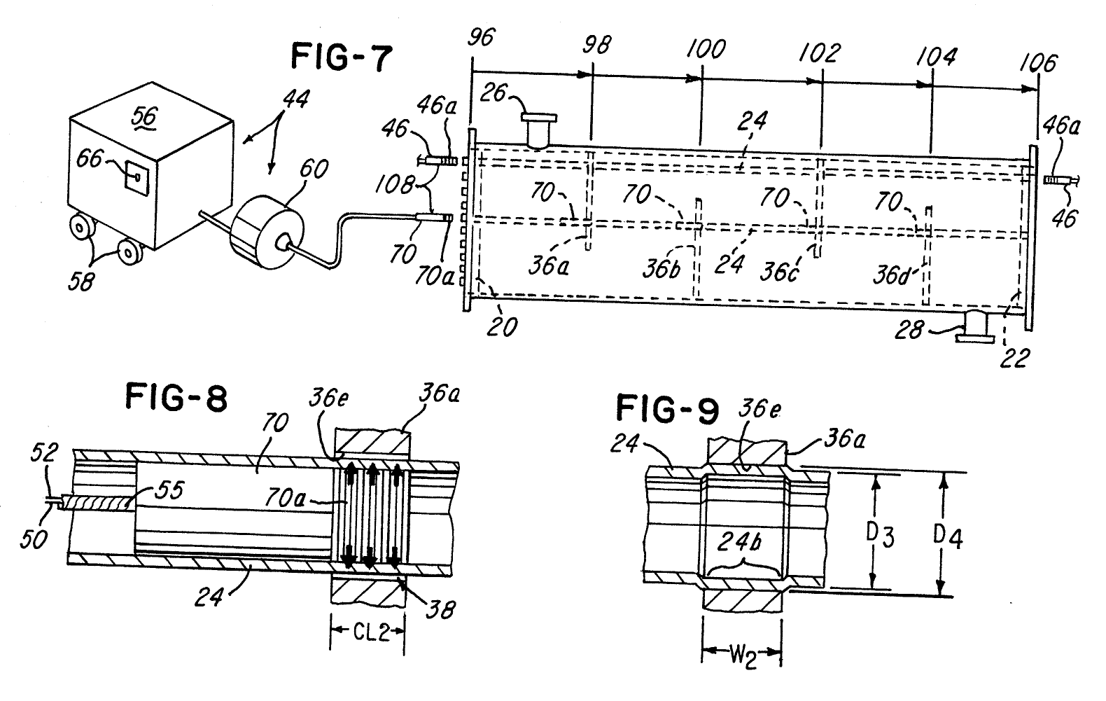

The system comprises a heat exchange tube expander 44 (FIGS. 1 and 7) for expanding the portion 24a (FIG. 6) and portion 24b (FIG. 9) as shown. The heat exchange tube expander 44 comprises a coil 46 which is conductively coupled to circuit 48 (FIG. 10) by an insulated cord 55 (FIG. 8) comprising a pair of conductors 50 and 52. The coil 46 may be a solenoid. Note that the circuit 48 is housed in a suitable housing 54 (FIGS. 2 and 7) that comprises a plurality of wheels 58, so that the heat exchange tube expander 44 is portable. As illustrated in FIG. 7, the heat exchange tube expander 44 may comprise a take-up mechanism 60, such as a reel or basket, for storing the insulated cord 54.

In the embodiment being described, the solenoid or coil 46 comprises a coil 46a which, as mentioned above, is coupled to the conductors 50 and 52 (FIG. 10). To facilitate moving the coil 46a into position, the coil 46a may be turned around a nonconductive tubular mandrel 62 (FIG. 5). In the embodiment being described, the nonconductive mandrel 62 is tubular and is made of glass fiber reinforced epoxy and may be sized to the tube inside diameter, depending on the inner diameter D₅ (FIG. 6) of the tube 24. In one embodiment, the coil 46a is housed with a sensor 132 (FIG. 17) as described later.

Referring now to FIG. 10, notice that the circuit 48 comprises a capacitor bank 64 that is coupled in series to a switch 66, a first resistor Rₛ, first inductor Lₛ and load inductor L_{L}, as shown. In the embodiment being described, the load inductor L_{L} is the coil 46a (FIGS. 4, 5 and 7). The coil 46a has a coil length C_{L1} (FIG. 4) that generally corresponds to the width W₁ (FIG. 6) of the sheet 20 so that the portion 24a is expanded to engage the entire surface of inner wall 20a of sheet 20. This provides an interference fit over the entire joint between tube wall 24c (FIG. 6) and inner wall 20a. Likewise, the heat exchange tube expander 44 may comprise a second solenoid 70 having a second coil 70a (FIGS. 8 and 9) comprising a second coil length C_{L2} that corresponds to the width W₂ (FIG. 9) of the baffle sheets 36a-36d. Thus, it should be understood that the lengths C_{L1} and C_{L2} of coils 46a and 70a are selected in response to the widths W₁ (FIG. 6) and W₂ (FIG. 9), respectively. Of course, widths W₁ and W₂ may vary depending on the sheets 20, 22 and 36a-36d used in the heat exchanger 10.

In the embodiment being described, the coils 46a and 70a each comprise 16 AWG square magnet wire. The coil 46a, for example, comprises at least 20 turns over a length C_{L1} of about one inch, and the coil 70a comprises at least 20 turns over a length C_{L2} of about one inch. Thus, the coils 46a and 70a are of similar construction, but in the embodiment being described they are operated at different power levels. It should be appreciated that the coils 46a and 70a may be of different construction if desired. The nominal inductance for the coils 46a and 70a is approximately 0.64 microhenries when inserted into one of the tubes 24. The nominal outside diameter of the coils 46a and 70a is slightly less than the diameter D₅ (FIG. 6) of the tube 24 so that the coils 46a and 70a can easily slide or pass through the passageway 24e of tube 24.

The capacitor discharge bank 64 of circuit 48 is capable of storing enough energy to perform the enlargement of the portion 24a (FIG. 6) and portion 24b (FIG. 9). It should be appreciated that the capacitor discharge bank 64 of circuit 48 is charged to an appropriate voltage level that will vary depending on, for example, the characteristics of the coil 46a, the portion 24a and portion 24b of the tube 24 to be enlarged, the characteristics of the sheets 20, 22 and 36a-36d and the like. During operation, the capacitor discharge bank 64 is charged by the power source 68 (FIG. 10). The switch 66 is then triggered to start current to flow through the coil 46a or coil 70a, depending on which coil that is being used. Through magnetic induction, the current flowing through the coil 46a induces an eddy current in the portion 24a that is directly opposed to the current flowing in coil 46a. This causes an electromagnetic expansion force that pushes or forces the portion 24a radially outwardly in the direction of arrows 71 and 72 (FIG. 5). This outward radial expansion of the portion 24a of tube 24 continues until the outer wall 24d (FIG. 6) of tube 24 impacts the inner wall 20a of sheet 20. It has been found that the radial expansion of the portion 24a of tube 24 impacts the inner wall 20a and causes the inner wall 24a to radially expand from its normal diameter D₂ to a slightly larger diameter. As the sheet 20 recovers from the impact from the wall 24d, the wall 20a will return or contract to substantially its original diameter D₂, thereby providing an interference pressure fit between the outer wall 24d of tube 24 and the inner wall 20a of sheet 20. This interference pressure can be of significant magnitude to allow scaling between the outer wall 24d of tube 24 and the inner wall 20a of sheet 20. This process and method is repeated at each intersection or joint between the tubes 24 and the inner walls of any surrounding members such as sheets 20 and 36. A method for assembling, manufacturing and repairing the heat exchanger 10 using the invention will now be described.

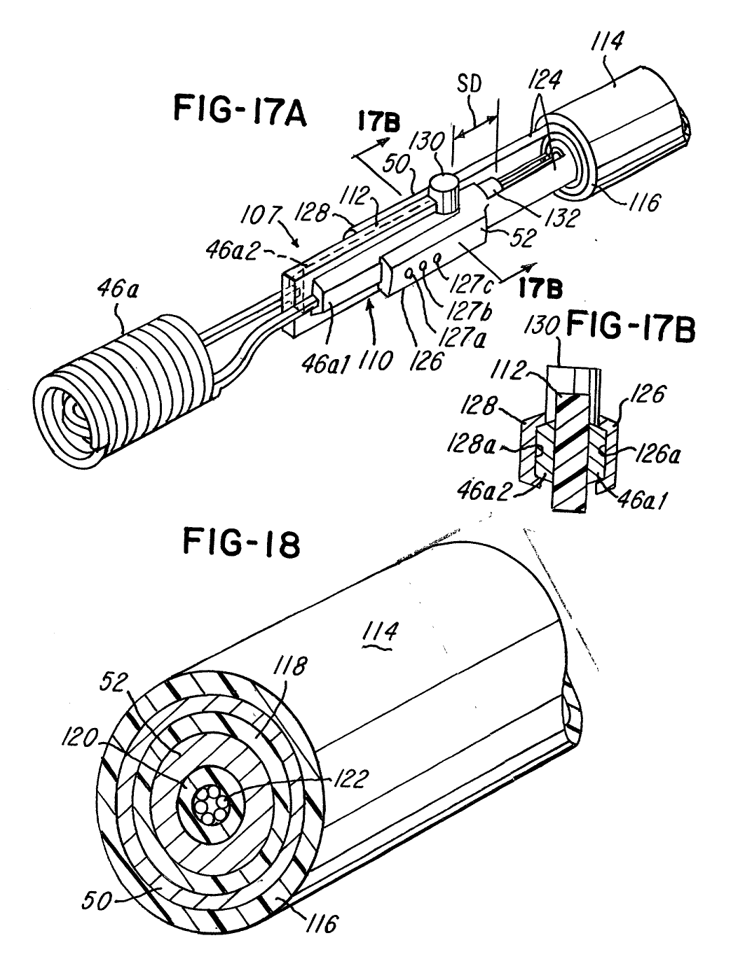

Referring to FIG. 17A, a detector and coil assembly 107 is shown. The assembly 107 comprises the sensor 132 for sensing the sheet 20, 22 and 36a-36d and the coil 46a. The assembly 107 comprises the coil 46a which is received in an insulated termination housing 110. It is envisioned that the coil 46a can be detachably removed from the housing 110 so that it can be replaced, substituted, serviced, or the like. Advantageously, the invention comprises a coaxial cable 114 having the conductors 50 and 52 formed of wire braids. As illustrated in FIG. 18, the coaxial cable 114 comprises an insulator 116, the conductor 50, an insulator 118, the conductor 52, an insulator 120, and a sensor bundle 122, which will be described later herein.

Notice that the cable 114 terminates into a cable termination housing 124 which provides a first mount 126 and a second mount 128. The first and second mounts 126 and 128 have recessed areas 126a and 128a (FIG. 17B) for receiving and conductively coupling to a complementary first coil end 46a1 and a complementary second coil end 46a2, respectively, of coil 46a. Note that the coil terminal ends 46a1 and 46a2 are separated by an insulator 112 and conductively engage the first and second mounts 126 and 128, and they each may comprise a plurality of apertures, such apertures 127a-127c of first mount 126, which become aligned so that they can be conductively coupled together with any suitable fastener or fastening means, such as a screw or bolt, weld or the like. This allows for a quick connection and disconnection of the coil ends 46a1 and 46a2 from the coaxial cable mounts 126 and 128, respectively.

A permanent magnet 130 is attached to the cable termination lug or mount 126 as shown. In the embodiment being described, the permanent magnet 130 generates a magnetic flux which is interrupted by a sheet 20, 22 or 36a-36d as the assembly 107 is moved through the tube 24. The coaxial cable 114 comprises the sensor 132 (FIGS. 10 and 17) that is coupled to the sensor bundle 122 (FIG. 18) contained in the center of the coaxial cable 114. The sensor 132 is a Hall effect sensor, but could comprise any suitable sensor capable of sensing the sheets 20, 22 and 36a-36d. The sensor 132 is positioned on the cable 114 so that when the connection to the coil 46a is made, the sensor 132 is positioned at an appropriate working distance from the permanent magnet 130.

The Hall effect sensor 132 cooperates with the permanent magnet 130 to sense a position of one of the sheets 20, 22 or 36a-36d as the assembly 107 is moved through the tube 24. In this regard, note that the sensor 132 is situated a predetermined distance SD from the magnet 130. When sensor 132 senses a sheet 20, 22 or 36a-36d, the sensor bundle 122 carries the signal to a controller 49 (FIG. 10) for controlling operation of the assembly 107 and power supply 68. In response, the controller 49 will energize a display 51 or alarm (not shown) to indicate that the coil 46a is operatively positioned to enlarge at least a portion of the tube 24 as described herein. The display 51 may be an LCD or other type of suitable display. The enlargement of at least a portion of tube 24 may then proceed to the next sheet 20, 22 and 36a-36d.

It should be understood that the first mount 126 is coupled to a negative side of the power supply 68 (FIG. 10), and the second mount 128 is coupled to a positive side of power supply 68. The pulse power will be fed to the coil 46a via the braided conductors 50 and 52. The cable 114 is designed to have voltage hold-off capability of at least 10 kV. Both braided conductors 50 and 52 are sized to have a cross-sectional area to safely carry a pulse current to a peak value of at least 35 kA at a rate of one pulse per five seconds or faster.

When required, a solder or sealing material (not shown) may be applied to the tube surface before forming the joint. Upon expansion of the tube 24, the solder or sealant melts or softens and the tube 24 presses the solder or sealant into the joint so as to fill any open spaces.

Advantageously, this system and method provides an assembly 107 for detecting or sensing a location of a sheet 20, 22 or 36a-36d and for enlarging at least a portion of tube 24. Note that the assembly 107 and cable 114 can be easily and quickly moved and positioned in and through tube 24. Also, the sensor bundle 122 (FIG. 18) and the braided conductors 50 and 52 are formed into a bundle which is centrally located within the insulator 116. This facilitates reducing the diameter of assembly 107. The method or process of the invention will now be described.

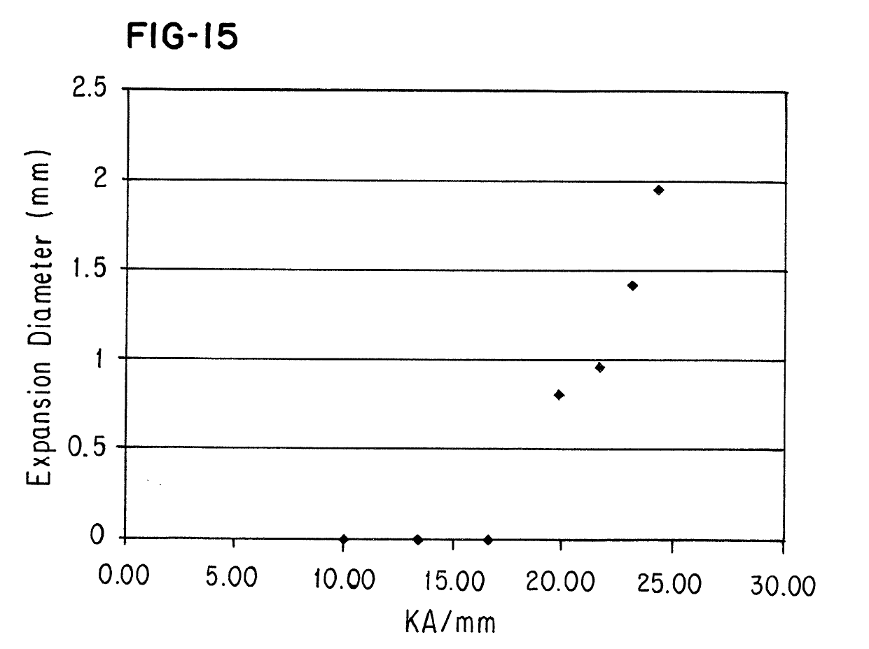

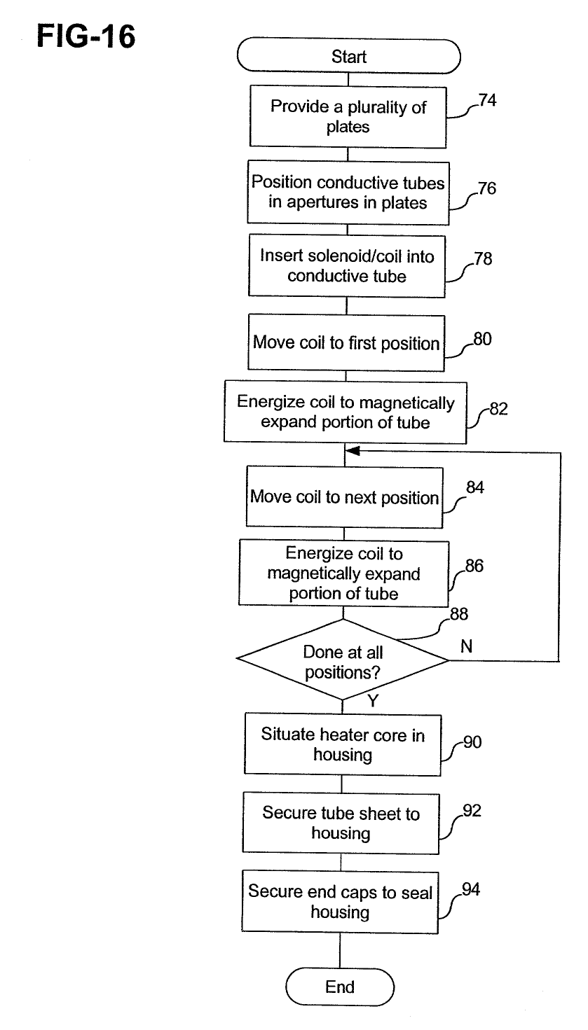

The method begins (block 74 in FIG. 16) by providing a plurality of sheets, such as sheets 20, 22 and 36a-36d that are secured to the housing 12. At block 76, the plurality of conductive tubes 24 are situated in the apertures 23 and 38 (FIG. 8) and between the sheets 20 and 22, as illustrated in FIGS. 1-3. The coil 46a is then aligned with the tube passageway 24e (FIG. 4) and inserted (block 78 in FIG. 16) into the passageway 24e of the tube 24. The coil 46a is then moved to a first position 96 (FIG. 7) until it is aligned with the sheet 20, as illustrated in FIG. 5. At this position, the coil 46a becomes generally aligned with the inner wall 20a of the sheet 20 in the illustration. As illustrated in FIG. 7, a plurality of other positions 98, 100, 102 and 104 correspond to a plurality of other positions or imaginary planes in which the baffle sheets 36a-36d may be situated. Similarly, the sheet 22 lies in an imaginary plane 106 and corresponds to another position at which solenoid 46a may be moved. For ease of description, only the fastening of portion 24a (FIG. 6) to tube sheet 20 is described, but it should be appreciated that the same technique is used to secure each tube 24 to any surrounding member, such as inner walls 20a and 36a.

Returning to the illustration, after the coil 46a is moved (block 80 in FIG. 16) to the first position 96 (FIG. 7) and generally aligned with the wall 20a of sheet 20, a user actuates switch 66 or if in automatic mode the device detects a sheet (FIGS. 2, 7 and 10) energizes the coil 46a. As a pulse of current flows through the coil 46, an opposite flowing eddy current is induced in the tube 24. This results in magnetic pressure acting on the tube 24 to expand the portion 24a of the tube 24 that is opposed to the coil 46a to expand or be forced radially outwardly in the direction of arrows 71 and 72 until the outer wall 24d (FIG. 6) of tube 24 engages the inner wall 20a of sheet 20, thereby securing the portion 24a of tube 24 to the inner wall 20a of sheet 20. It may be desirable to repeatably pulse the current through the coil 46a, particularly if a large distance between the wall 24c and inner wall 20a exists. In the embodiment described, the current is pulsed for approximately 20 micro seconds.

The coil 46a is then moved (block 84 in FIG. 16) to the next position, such as position 106 for coil 46a, where the coil 46a is again energized (block 86 in FIG. 16) to secure the tube 24 to the tube sheet 22. As mentioned earlier herein, if a width W₁ (FIG. 4) of sheet 20 is different than the width W₂ (FIG. 8) of sheet 36, then it may be desirable to use a different coil, such as the coil 70a at the positions 98-104 (FIG. 7). Preferably a coil having the length C_{L2} corresponding to the width W₂ (FIG. 9) of the baffle sheet 36a should be used. This coil 70a would be used for each of the positions 98, 100, 102 and 104 to secure each of the plurality of tubes 24 to the inner walls, such as inner wall 36e of baffle sheet 36a, of any surrounding baffle sheets 36a-36d. At decision block 88, it is determined whether the process is complete at all positions. If it is, the process proceeds as shown, but if not, the process loops back to block 84. As mentioned earlier, the process can be conducted from only one of the ends 12c or 12d, or from both ends 12c and 12d.

In the example, the solenoid or coil 46a traverse the entire length L of tube 24 creating tube sheet joint at each position where the sheets 20 and 22 surround the tube 24. The system then automatically traverses the solenoid or coil 46a in an opposite direction and the tube 24 is expanded at each position where a baffle plate 36a-36d surrounds it. Automatic positioning may be accomplished using the sensor (FIG. 7) mentioned earlier. The traverse speed through the tube may be on the order of about 60 feet/minute, but this speed could be higher or lower if desired.

It is contemplated that the system and method of the invention can be used to manufacture or assemble the tube bundle 18 comprising the sheets 20, 22 and 36a-36d secured to the plurality of tubes 24 outside of housing 12, as alluded to earlier herein. The assembled tube bundle 18 is then mounted in the surrounding housing 12. Alternatively, the housing 12 may be provided with one or more of the sheets 20, 22 or 36a-36d mounted therein. The plurality of conductive tubes 24 are then inserted in the sheets 20, 22 and 36a-36d. In this case, the system and method is used to secure the plurality of conductive tubes 24 to the sheets 20, 22 and 36a-36d after the plurality of conductive tubes 24 are situated in apertures 23 and 38, as mentioned in the illustration.

If the tube bundle 18 is assembled outside of the housing 12, then the routine proceeds to block 90 in FIG. 15 where the tube bundle 18 is situated in the housing 12 and the sheets 20 and 22 are secured to the housing 12 (block 92). The first header or end bell 14 and a second header or end bell 16 are then secured to the housing 12 by bolting the flanges 14a and 16a to the flanges 12a and 12b, respectively, as shown in FIG. 1.

It should be appreciated that the heat exchange tube expander 44 may further comprise a sensor 108 (FIG. 7) for sensing the positions 96-106 to facilitate a quick alignment of the coils 46a and 70a in the various imaginary planes in which the sheets 20, 22 and 36a-36d lie. One example of such a sensor is the Hall effect sensor 122 (FIG. 17) or eddy current probe, such as is shown by U.S. Pat. No. 4,889,679 which is incorporated herein and made a part hereof.

In one embodiment, the tube 24 is expanded into the apertures 23 in the sheets 20 as the coil 46a is in motion in the tube 24. Upon energizing the coil 46a, the tube 24 expands almost instantaneously. Accordingly, it is not necessary to bring the coil 46a to a complete stop each time a joint is formed. The coil 46a can be automatically activated each time the coil 46a aligns with the sheet 20 by coupling the coil 46a with the sensor mentioned herein or by closing the switch 66 in the coil circuit 48 each time the coil 46a travels to a pre-measured point in the tube 24. In either case, in this embodiment, as the coil 46a travels continuously through the tube 24, the tube 24 is automatically energized and the tube 24 is expanded “on the fly,” without stopping. Of course, those skilled in the art will appreciate that if necessary, the coil 46a could be slowed as it aligns with each sheet 20 or the coil 46a could momentarily stop. However, for many tube designs and constructions, it will be possible to form joints “on the fly” while the coil 46a is moving.

Although the embodiment described and shown herein shows a plurality of coils 46a and 70a, it should be appreciated that more or fewer coils may be used if desired. Also, the coils 46a and 70a may be comprised of different gauge wire, different lengths, different number of turns and the like.

It should further be appreciated that the system and method of the present invention may be used to assemble and manufacture a heat exchanger 10 and may be used to repair any intersection or joint between the tube 24 and one of the sheets 20, 22 and 36a-36d. During repair, one or both of the end bells 14 and 16 must be removed to gain access to the tubes 24.

A further feature of Applicants' invention is that the heat exchange tube expander 44 comprises a plurality of wheels 58 secured to housing 56 so that it can be moved, for example, from the first end 12c (FIG. 2) to the second end 12d (FIG. 3). This is particularly convenient when assembling, manufacturing or repairing heat exchangers having a length L (FIG. 1) over 96 inches. The heat exchange tube expander 44 may be used from either one of the ends 12c or 12d or both ends 12c or 12d as mentioned previously, whereupon the coil 46a would be moved through the entire tube 24, which time is saved in not moving the expander to the opposite end of the heat exchanger. Alternatively, the heat exchange tube expander 44 may be used at one of end 12c to, for example, expand portions over the approximately one-half a length (i.e.—to the middle of the tube 24) of tube 24, withdraw the coil 46a, whereupon the coil 46a may be inserted into the tube from the opposite end 12d and then energized to expand portions of the second half of tube 12.

### EXAMPLE

One example of Applicants' invention will now be described. Applicants used a tube 24 having a nominal outside diameter of 0.74 inches and a nominal inside diameter of 0.59 inches. The coil 46a was made from 16 AWG square magnet wire and consisted of 22 turns over a length of about 1.25 inches. The nominal inductance for the coil 46a was approximately 0.5 microhenries when inserted into the tube 24. The outside diameter of the coil 46a was about 0.565 inch. The coil 46a was connected to the circuit 48 that had a capacitor discharge bank 64 having a total capacitance of about 50 microfarads. The capacitors (not shown) comprising the capacitor discharge bank 64 were charged to a voltage of about 7.5 kV resulting in a total current of about 35 kA through the coil 46a. The total stored energy based on these values was approximated at 1406 Joules.

The coil 46a was inserted into the tube 24 and positioned in operative relationship with the wall 20a of sheet 20, with the tube 24 situated therebetween. It should be appreciated that the inner wall 20a had a diameter of about 0.76 inch, and the sheet 20 had a thickness or width W₁ (FIG. 6) of approximately 1.25 inches. The switch 66 was triggered which induced a current to flow through coil 46a. This, in turn, caused the portion 24a to impact inner wall 20a as it expanded. As the wall 20a recovered to substantially its original dimension (D₂ in FIG. 6), it caused an interference pressure between the surface 24d (FIG. 5) and the inner wall 20a. The interface pressure was significant enough to secure the tube 24 to the sheet 20. Preferably, transport apparatuses analogous to the devices used to transport mechanical tube expanders used in the past may be employed for transporting the detector assembly 107 (FIG. 17) and coil 46a.

In the example being described, the total stored energy was 1400 Joules, total capacitance was 50 microfarads and the total load inductance L_{L} in the tube 24 was about 0.5 microhenries. The total system inductance Lₛ was about 1.4 microhenries and total system resistance Rₛ was 10-20 milliohms with a peak current of about 35 kA in tube 24. The coil 46a was driven with a ringing pulse lasting approximately 200 microseconds. The rise time of the first current peak is 10-20 microseconds. Most of the forming or expansion of the tube 24 occurs during the first peak.

FIG. 15 illustrates further expansion result data for an enhanced heat transfer tube 24. The x-axis of the chart in FIG. 15 represents a peak magnetic pressure applied and the y-axis correlates to the expansion results. Note that as the current increased, the bulge diameter of the tubes 24 increased. For example, significant expansion was not observed until a current of at least 15 kA/mm after this level, the diametrical expansion increased approximately linearly to a value of nearly 2 mm at a current of 25 kA/mm.

Although the embodiment has been shown and described relative to an illustrative embodiment, a particular example and some particular data to illustrate various features of the invention, it should be appreciated that the various values achieved may change depending on the coil 46a or 70a used; thickness of tube 24; the inner and outer diameters of the tube 24; the dimensions D₁-D₄, W₁, W₂, C_{L1} and C_{L2}; the material comprising the tube 24 and the sheets 20, 22, 36a-36d and the like. In the embodiment being described, the components of the circuit 48 may also change. What is important, however, is that the coil used be configured to be capable, through magnetic induction, to expand at least that portion 24a (FIG. 6) and portion 24b (FIG. 9) of tube 24 to engage and secure the tube 24 to the sheet 20, 22 or 36a-36d that surrounds the tube 24.

In the embodiment being described, the tubes 24 are copper and comprise a length of about 240 inches and have an outer diameter of about ¾ inch. The tubes 24 may comprise internal spiral ridges and external formed fins (not shown) to further facilitate heat exchange. The distance between the sheets 20 and 22 and varies depending on the heat exchanger manufacturers requirements and TEMA Standards. The heat exchanger 10 comprises four baffle sheets 36a-36d in the embodiment shown, but it could comprise more, fewer, or even no baffle sheets 36a-36d as required by TEMA Standards for heat exchanger construction. Moreover, a distance between the position of the sheets 20, 22 and 36a-36d, such as a distance between position 96 and 98 or a distance between position 100 and 102 in FIG. 7, is approximately 19 inches in the embodiment being described. Of course, this distance could be varied depending on, for example, the number or sheets 36a-36d or the interference of the fluid flow pattern desired as specified by the heat exchanger manufacturer.

Heat exchangers are manufactured in a variety of lengths, diameters, quantity of tubes and heat transfer medias. These configurations are established by the heat exchanger manufacturer and are derived from end user requirements.

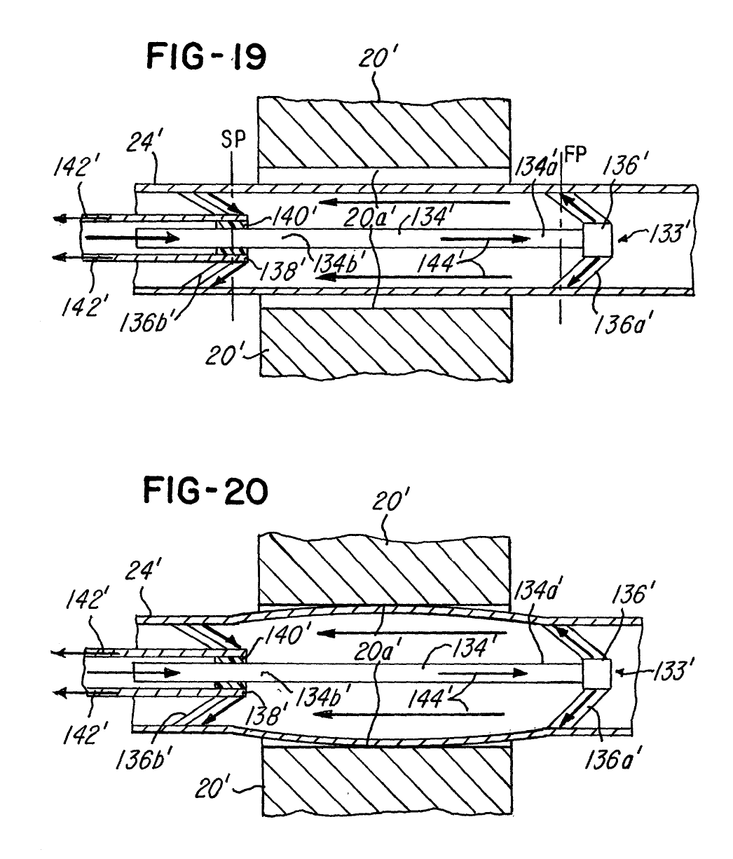

Other means for magnetically expanding tube 24 can also be used. One such means is referred to herein as a direct drive expander in which FIGS. 19 and 20 illustrate another embodiment of the invention. It should be understood that like parts and parts in this embodiment are identified with the same part numbers, except that an apostrophe (“'”) has been added to part numbers in FIGS. 19 and 20. It should be understood that in this embodiment, a direct drive expander 133′ is provided for enlarging at least the portion 24a′ (FIG. 6) of tube 24′. The direct drive expander 133′ comprises a core conductor 134′. The conductor 134′ is coupled to a first compliant contact 136′ at a first end 134a′. A second compliant contact 138′ is situated on a second end 134b′ of conductor 134′. Notice in FIG. 19 that an insulator 140′ is situated between the second compliant contact 138′ and the conductor 134′ as shown. The conductor 134′ is coupled to a positive side of the power supply 68′ (FIG. 10), and the conductor 138′ is coupled to the negative side of the power supply 68′.

Each of the first and second compliant contacts 136′ and 138′ comprise a brush 136a′ and 136b′ for providing a continuous contact with the portion of the inner wall of tube 24′ that lies in a first plane FP and second plane SP, respectively, as illustrated in FIG. 19.

During use, the direct drive expander 133′ is situated in operative relationship with the sheet 20′ as illustrated in FIG. 19. For this purpose, a sensor, such as sensor 132′ (FIG. 10), may be employed with the direct drive expander 133′ to align it with a sheet 20′, 22′ or 36a′-36d′. After the direct drive expander 133′ is situated in operative relationship with the sheet 20′, the switch 66′ (FIG. 10) may be closed to cause electric current to flow through the conductor 134′ in the direction of arrow 144′ as illustrated. The current flows from the first contact 136′ through the tube 24′, through the second contact 138′ and then back to the power supply 68′. When the electrical current flows in the manner illustrated by the arrows 144′, electromagnetic pressure is created upon the wall of tube 24′. When the magnetic pressure is applied, the tube 24′ expands in a radial direction, as illustrated in FIG. 20. As the diameter of the tube 24′ increases, it ultimately engages the inner wall 20a′ to secure the tube 24′ to the sheet 20′ as shown.

It should be appreciated that the first and second contacts 136′ and 138′ may be comprised of compliant brushes which may be flexible to permit the direct drive enlarger 133′ prime to be driven through the tube 24′ either manually or with a feeding mechanism (not shown). The direct drive expander 133′ may also be used with the cable 114′ described earlier.

Advantageously, these systems and methods provide means for manufacturing, assembling and even repairing a tubular heat transfer system 10. The system and method further provides means for expanding a dimension of a tube 24 in a tube bundle 18 or used in a tubular heat transfer system 10 to facilitate securing the tube 24 to one or more of the sheets 20, 22 and 36a-36d situated in the tubular heat transfer system 10 by magnetically expanding at least a portion of the tube 24. This technique is believed to be superior to techniques, such as mechanical expansion techniques, of the past. The system and method improve the means by which tubes 24 are secured to one or more of the sheets 20, 22 and 36a-36d in a tubular heat transfer system 10 and improve the joints between the tubes 24 and any surrounding walls, such as wall 20a of sheet 20.

While the systems and methods herein described, and the forms of apparatus for carrying these systems and methods into effect, constitute one embodiment of this invention, it is to be understood that the invention is not limited to these precise methods and forms of apparatus, and that changes may be made in either without departing from the scope of the invention, which is defined in the appended claims.

What is claimed is:

1. A method for securing a conductive tube to at least one surrounding member of a tubular heat transfer system, said method comprising the steps of:
inserting a coil into said conductive tube until said coil is positioned in operative relationship with said conductive tube and said at least one surrounding member;
energizing said coil to expand a portion of the conductive tube to engage said at least one surrounding member, thereby securing said conductive tube to said at least one surrounding member.

2. The method as recited in claim 1 wherein said method further comprises the steps of:
providing at least one surrounding member having at least one aperture therein;
situating said conductive tube in said at least one aperture before performing said inserting step.

3. The method as recited in claim 2 wherein said at least one surrounding member comprises a sheet.

4. The method as recited in claim 3 wherein said sheet comprises a baffle or support sheet.

5. The method as recited in claim 3 wherein said sheet comprises a tube sheet.

6. The method as recited in claim 4 wherein said energizing step provides a fluid-tight seal between said conductive tube and said surrounding member.

7. The method as recited in claim 1 wherein said coil comprises a mandrel.

8. The method as recited in claim 1 wherein said method further comprises the steps of:
surrounding a plurality of conductive tubes with said at least one surrounding member;
performing said inserting and energizing steps in each of said plurality of conductive tubes to join said plurality of conductive tubes to said at least one surrounding member.

9. The method as recited in claim 8 wherein said method further comprises the steps of:
inserting said plurality of conductive tubes with into a plurality of apertures of a plurality of surrounding members;
performing said inserting and energizing steps at each position where said tube intersects a surrounding member.

10. The method as recited in claim 9 wherein said each of said plurality of surrounding members comprises a sheet.

11. The method as recited in claim 1 wherein said energizing step further comprises the steps of:
providing a capacitor discharge bank that provides a predetermined capacitance;
charging said capacitor discharge bank with a predetermined voltage;
discharging said capacitor discharge bank to energize said coil to perform said energizing step.

12. The method as recited in claim 11 wherein said conductive tube comprises a conductive tube dimension and said surrounding member comprises an inner wall comprising an inner wall dimension, said method further comprising the step of:
selecting said predetermined capacitance and said predetermined charge voltage in response to at least said conductive tube dimension and said inner wall dimension.

13. The method as recited in claim 1 wherein said coil comprises a solenoid.

14. The method as recited in claim 1 wherein said conductive tube comprises a copper tube.

15. A method for securing a plurality of conductive tubes to a plurality of plates to provide a tube bundle in a tubular heat transfer system, each of said plurality of plates having a plurality of inner walls defining a plurality of apertures, respectively, said method comprising the steps of:
situating said plurality of conductive tubes in said plurality of apertures, respectively, and magnetically increasing a diameter of a portion of at least one of said plurality of conductive tubes into engagement with at least one of said plurality of inner walls, thereby securing said at least one of said plurality of conductive tubes to said at least one of said plurality of inner walls.

16. The method as recited in claim 15 wherein said method further comprises the steps of:
situating a coil inside said at least one of said plurality of conductive tubes; and
energizing said coil to perform said increasing step.

17. The method as recited in claim 15 wherein said method further comprises the step of:
situating said plurality of plates in a predetermined relationship relative to each other.

18. The method as recited in claim 17 wherein said predetermined relationship provides at least one baffle in said tubular heat transfer system.

19. The method as recited in claim 16 wherein said energizing step further comprises the steps of:
providing a capacitor discharge bank comprising a predetermined capacitance;
charging said capacitor discharge bank comprising a predetermined charge voltage;
discharging said capacitor discharge bank to energize said solenoid to perform said energizing step.

20. The method as recited in claim 19 wherein said predetermined capacitance is at least 50 microfarads.

21. The method as recited in claim 16 wherein said method further comprises the step of:
sensing said surrounding member and energizing said coil when said coil is positioned in operative relationship with said surrounding member.

22. The method as recited in claim 12 wherein said method further comprises the step of:
sensing a next position of said plurality of positions and performing said energizing step at said next position.

23. The method as recited in claim 16 wherein said coil comprises a solenoid.

24. The method as recited in claim 16 wherein at least one of said conductive tube comprises a copper tube.

25. A method for enlarging a first portion and a second portion of a conductive tube for use in a tubular heat transfer system, said method comprising the steps of:
moving a coil to a first position in operative relationship with said first portion of said conductive tube;
energizing said coil to enlarge magnetically said first portion of said conductive tube at said first position;
moving said coil to the second position in operative relationship with said second portion of said conductive tube; and
energizing said coil to enlarge magnetically said second portion of said conductive tube at said second position.

26. The method as recited in claim 25 wherein said method further comprises the steps of:
inserting said conductive tube in a first surrounding member located at said first position and a second surrounding member located at said second position;
performing said first energizing step to secure said first portion of said conductive tube to said first surrounding member; and
performing said second energizing step to secure said second portion of said conductive tube to said second surrounding member.

27. The method as recited in claim 25 wherein said method further comprises the steps of:
sensing said first position before said first energizing step;
sensing said second position after said first energizing step, but before said second energizing step.

28. The method as recited in claim 26 wherein said method further comprises the steps of:
sensing a position of said first surrounding member before said first moving step;
sensing a position of said second surrounding member before said second moving step and after said first energizing step.

29. The method as recited in claim 26 wherein said first surrounding member comprises a first sheet and a second surrounding member comprises a second sheet.

30. The method as recited in claim 29 wherein said first sheet and said second sheet are baffle or support sheets.

31. The method as recited in claim 29 wherein at least one of said first sheet or said second sheet comprises a tube sheet.

32. The method as recited in claim 25 wherein said energizing steps further comprise the step of:
enlarging a portion of said conductive tube from a first diameter to a second diameter.

33. The method as recited in claim 32 wherein said second diameter is varied depending in response to the tubular heat transfer system design parameters and manufacturing tolerances per TEMA specifications percent larger than said first diameter.

34. The method as recited in claim 25 wherein said coil comprises a solenoid.

35. The method as recited in claim 25 wherein said conductive tube comprises a copper tube.

36. A method for assembling a tubular heat transfer system having a housing, said method comprising the steps of:
(a) providing a plurality of sheets, each of said plurality of sheets comprising a plurality of inner walls defining a plurality of apertures, respectively;
(b) positioning a plurality of conductive tubes into said plurality of apertures, respectively;
(c) inserting a coil into a first conductive tube of said plurality of conductive tubes;
(d) moving said coil to a first position in said first conductive tube; said first position corresponding to where a first inner wall of said plurality of inner walls and said coil become substantially aligned;
(e) energizing said coil to enlarge magnetically said first portion of said first conductive tube adjacent the first inner wall to secure said first portion of said first conductive tube to said first inner wall;
(f) moving a second coil to a next position in said first conductive tube; said second position corresponding to where said a second inner wall of a second sheet and said coil become substantially aligned;
(g) energizing said coil to enlarge magnetically said second portion of said first conductive tube adjacent the second inner wall to secure said second portion of said first conductive tube to said second inner wall; and
(h) repeating said steps (f) and (g) until each of said plurality of conductive tubes is secured to said plurality of sheets.

37. The method as recited in claim 36 wherein said method further comprises the step of:
situating said plurality of sheets in a predetermined relationship to define a heat exchange area, an inlet area and an outlet area, said plurality of conductive tubes enabling fluid communication between said inlet area and said outlet area within the housing.

38. The method as recited in claim 37 wherein said predetermined relationship provides at least one baffle in said tubular heat transfer system.

39. The method as recited in claim 36 wherein said energizing step further comprises the steps of:
providing a capacitor discharge bank coupled to said coil with a predetermined capacitance;
charging said capacitor discharge bank with a predetermined charge voltage;
discharging said capacitor discharge bank to energize said coil to perform said energizing step (e).

40. The method as recited in claim 39 wherein each of said plurality of conductive tubes comprise a conductive tube outer diameter and each of said plurality of surrounding members comprises a surrounding member inner wall diameter, said method further comprising the step of:
selecting said predetermined capacitance and said predetermined charge voltage in response to said conductive tube outer diameter and said surrounding member inner wall diameter.

41. The method as recited in claim 36 wherein said method further comprises the step of:
sensing said first position before performing said step (e).

42. The method as recited in claim 41 wherein said method further comprises the step of:
sensing said second position before performing said step (g).

43. The method as recited in claim 36 wherein said plurality of sheets comprises a plurality of baffle sheets and a plurality of tube sheets, said step (a) further comprising the step of:
situating said plurality of baffle sheets between said plurality of tube sheets.

44. The method as recited in claim 36 wherein a length of said first portion generally corresponds to a width of said first inner wall.

45. The method as recited in claim 36 wherein said method further comprises the step of:
aligning said plurality of sheets so that the plurality of apertures in each of said plurality of sheets are generally aligned before said step (b).

46. The method as recited in claim 36 wherein said plurality of inner walls each define an inner wall diameter, said energizing steps further comprising the step of:
enlarging a diameter of said conductive tube at said first position and said second position to beyond said inner wall diameter during at least one of said energizing steps (e) and (g).

47. The method as recited in claim 36 wherein said method further comprises the step of: arranging said plurality of sheets on said plurality of conductive tubes to provide a baffle for fluid flowing through the tubular heat transfer system.

48. The method as recited in claim 36 wherein said coil comprises a solenoid.

49. The method as recited in claim 36 wherein said conductive tube comprises a copper tube.

50. A tube bundle for use in a tubular heat transfer system, comprising:
a plurality of sheets comprising a plurality of walls defining a plurality of apertures, respectively;
a conductive tube situated in each of said plurality of apertures; and
said conductive tube comprising an enlarged portion at each of a plurality of positions at which at least one of said plurality of walls surrounds said tube, thereby causing an interference fit between said enlarged portion and said at least one of said plurality of walls engaged by said enlarged portion; wherein said conductive tube comprises a continuously enhanced tube.

51. The tube bundle as recited in claim 50 wherein each of said conductive tube comprises a tube diameter and said enlarged portion comprises an enlarged portion diameter that is greater than said tube diameter by at least about 10-15 percent.

52. The tube bundle as recited in claim 50 wherein said plurality of sheets are arranged around said plurality of conductive tubes to provide a baffle for fluid flowing through said tubular heat transfer system.

53. The tube bundle as recited in claim 50 wherein at least two of said plurality of sheets comprise tube sheets for defining a heat exchange area, an inlet area and an outlet area in a housing of said tubular heat transfer system so that fluid may flow through said plurality of conductive tubes.

54. The tube bundle as recited in claim 50 wherein said tubular heat transfer system provides at least one of the following: an air conditioner, a heat exchanger, a chiller, a boiler or an absorption unit.

55. The tube bundle as recited in claim 50 wherein said enhancements in said continuously conductive tube are substantially maintained following expansion.

56. The tube bundle as recited in claim 50 wherein said conductive tube comprises a copper tube.

57. A tubular heat transfer system comprising:
a plurality of sheets comprising a plurality of walls defining a plurality of apertures, respectively;
a plurality of conductive tubes situated in said plurality of apertures, respectively; each of said plurality of walls surrounding each of said plurality of conductive tubes at a plurality of positions;
each of said plurality of conductive tubes comprising an enlarged portion at each of said plurality of positions to cause an interference pressure between said enlarged portion and at least one of said plurality of walls engaged by said enlarged portion, thereby securing said plurality of conductive tubes to said plurality of walls to provide a tube bundle; and
a housing for surrounding said tube bundle;
each of said plurality of conductive tubes comprising a continuously enhanced tube;
said plurality of sheets comprising a first tube sheet and a second tube sheet for sealing said housing to define an inlet area, a heat exchange area, and an outlet area;
said housing having an inlet opening associated with said inlet area and an outlet opening associated with said outlet area, said plurality of conductive tubes enabling communication of fluid between said inlet area and said outlet area.

58. The tubular heat transfer system as recited in claim 57 wherein each of said plurality of conductive tubes comprises a tube diameter and said enlarged portion comprises an enlarged portion diameter that is greater than said tube diameter by at least about 10-15 percent.

59. The tubular heat transfer system as recited in claim 57 wherein said plurality of sheets are arranged around said plurality of conductive tubes to provide a baffle for fluid flowing through said tubular heat transfer system.

60. The tubular heat transfer system as recited in claim 57 wherein said housing further comprises a second inlet opening in communication with said heat exchange area and a second outlet opening in communication with said heat exchange area for permitting fluid of a first temperature to flow through said heat exchange area and around said plurality of conductive tubes while fluid of a second temperature flows through said plurality of conductive tubes, said first and second temperatures being different in order to provide heat exchange.

61. The tubular heat transfer system as recited in claim 60 wherein said plurality of sheets are arranged around said plurality of conductive tubes to provide a baffle in said heat exchange area for fluid flowing between said second inlet opening and said second outlet opening.

62. The tubular heat transfer system as recited in claim 60 wherein said fluid of said second temperature flows in a first direction and fluid of said first temperature flows in a second direction substantially different from said first direction.

63. The tubular heat transfer system as recited in claim 57 wherein said tubular heat transfer system provides at least one of the following: an air conditioner, a heat exchanger, a chiller, a boiler or an absorption unit.

64. The tubular heat transfer system as recited in claim 57 wherein said enlarged portion comprises a magnetically enlarged portion.

65. The tubular heat transfer system as recited in claim 57 wherein said conductive tube comprises a copper tube.

66. A heat exchange tube expander for use relative to a tubular heat transfer system comprising a plurality of conductive tubes, said heat exchange tube expander comprising:
a coil for inserting into at least one of said plurality of conductive tubes;
a transport for positioning the coil at a plurality of positions in said at least one of said plurality of conductive tubes;
a circuit coupled to said coil, said circuit comprising a capacitor discharge bank having a predetermined capacitance and being capable of receiving a predetermined charge voltage; and
a switch for discharging said capacitor discharge bank to energize said coil to increase a diameter of at least a portion of said at least one of said plurality of conductive tubes to force an outer surface of said at least a portion into engagement with a surrounding member.

67. The heat exchange tube expander as recited in claim 66 wherein said coil comprises a solenoid that can be positioned at a plurality of positions along a length of each of said plurality of conductive tubes.

68. The heat exchange tube expander as recited in claim 66 wherein said coil comprises a length that generally corresponds to a width of said surrounding member.

69. The heat exchange tube expander as recited in claim 66 wherein said tubular heat transfer system tube expander further comprises:
a sensor for sensing said plurality of positions.

70. The heat exchange tube expander as recited in claim 66 wherein said predetermined capacitance is at least 50 microfarads.

71. The heat exchange tube expander as recited in claim 66 wherein said conductive tube is a finned tube.

72. The heat exchange tube expander as recited in claim 66 wherein the heat exchange tube expander includes the additional step of applying a sealing material to an outer circumference of the tube where the tube is surrounded by the surrounding member.

73. The heat exchange tube expander as recited in claim 72 wherein the sealing material is a solder or chemical sealant.

74. The heat exchange tube expander as recited in claim 66 wherein said conductive tube comprises a copper tube.

75. The heat exchange tube expander as recited in claim 66 wherein said expander comprises:
a cable having a first mount and a second mount for detachably coupling to said coil;
a sensor associated with the mount for sensing said surrounding member.

76. The heat exchange tube expander as recited in claim 75 wherein said cable comprises a sensor core for coupling said sensor to a controller.

77. The heat exchange tube expander as recited in claim 76 wherein said sensor is a Hall effect sensor.

78. The heat exchange tube expander as recited in claim 75 wherein said cable is extruded and comprises a sensor bundle, a first conductor and a second conductor, said first and second conductors conductively coupling said coil to said circuit.

79. A method for securing a conductive tube to a surrounding member of a tubular heat transfer system, said method comprising the steps of:
inserting a coil into a conductive tube;
moving said coil along the inside of said tube;
when said coil reaches a position at which said tube intersects said surrounding member, while the coil is moving, energizing said solenoid to expand the portion of the conductive tube at the position of intersection and thereby securing said conductive tube to said surrounding member.

80. The method of claim 79 wherein the method includes the additional steps of:
moving the coil to a second position at which said tube intersects a surrounding member, and
when said coil reaches said second position, while said coil is moving, energizing said coil to expand the portion of the conductive tube at the position of intersection and thereby securing said conductive tube to said surrounding member.

81. The method of claim 79 wherein the method includes the additional steps of sensing the position at which said tube intersects said surrounding members and energizing said coil in response to sensing said intersection.

82. The method of claim 80 wherein the method includes the additional steps of sensing the position at which said tube intersects said surrounding members and energizing said coil in response to sensing said intersection.

83. The method of claim 79 wherein the method includes the additional steps of determining the position at which said tube intersects said surrounding members and energizing said coil in response to determining said intersection.

84. The method of claim 80 wherein the method includes the additional steps of determining the position at which said tube intersects said surrounding members and energizing said coil in response to determining said intersection.

85. A tube bundle for use in a tubular heat transfer system, comprising:
a plurality of sheets comprising a plurality of walls defining a plurality of apertures, respectively;
a conductive tube situated in each of said plurality of apertures; and
said conductive tube comprising a magnetically enlarged portion at each of a plurality of positions at which at least one of said plurality of walls surrounds said tube, thereby causing an interference fit between said magnetically enlarged portion and said at least one of said plurality of walls engaged by said magnetically enlarged portion.

86. The tube bundle as recited in claim 85 wherein each of said conductive tube comprises a tube diameter and said enlarged portion comprises a magnetically enlarged portion diameter that is greater than said tube diameter by at least 10-15 percent.

87. The tube bundle as recited in claim 85 wherein said plurality of sheets are arranged around said plurality of conductive tubes to provide a baffle for fluid flowing through said tubular heat transfer system.

88. The tube bundle as recited in claim 85 wherein at least two of said plurality of sheets comprise tube sheets for defining a heat exchange area, an inlet area and an outlet area in a housing of said tubular heat transfer system so that fluid may flow through said plurality of conductive tubes.

89. The tube bundle as recited in claim 85 wherein said tubular heat transfer system provides at least one of the following: an air conditioner, a heat exchanger, a chiller, a boiler or an absorption unit.

90. The tube bundle as recited in claim 85 wherein enhancements in said continuously conductive tube are substantially maintained.

91. The tube bundle as recited in claim 85 wherein said conductive tube comprises a continuously enhanced tube.

92. The tube bundle as recited in claim 85 wherein said conductive tube comprises a copper tube.

93. An expander assembly comprising:
an expander for magnetically enhancing at least a portion of a tube into a surrounding member; and
a sensor connected with the expander for sensing a position of the surrounding member as the expander is moved through the tube.

94. The expander assembly as recited in claim 93 wherein said expander assembly comprises:
a cable having a first mount and a second mount for detachably coupling to said direct drive expander;
a sensor associated with the mount for sensing said surrounding member.

95. The expander assembly as recited in claim 94 wherein said cable comprises a sensor core for coupling said sensor to a controller.

96. The expander assembly as recited in claim 93 wherein said sensor is a Hall effect sensor.

97. The expander assembly as recited in claim 94 wherein said cable is extruded and comprises a sensor bundle, a first conductor and a second conductor, said first and second conductors conductively coupling said coil to said circuit.

98. The expander assembly as recited in claim 93 wherein said expander assembly comprises a sensor for sensing the surrounding member as the direct drive expander is moved through the tube.

99. The expander assembly as recited in claim 93 wherein said surrounding member is a sheet.

100. The expander assembly as recited in claim 93 wherein said expander is a coil.

101. The expander assembly as recited in claim 100 wherein said coil is a solenoid.
